(19) United States
(12) Patent Application Publication
(10) Pub. No.: US 2019/0090158 A1
(43) Pub. Date: Mar. 21, 2019

(54) ENHANCED NETWORK-ASSISTED SERVICES

(71) Applicant: QUALCOMM Incorporated, San Diego, CA (US)

(72) Inventors: Soumya DAS, San Diego, CA (US); Olufunmilola Omolade Awoniyi-Oteri, San Diego, CA (US); Amit Goel, San Diego, CA (US); Ashutosh Aggarwal, San Diego, CA (US); Edwin Chongwoo Park, San Diego, CA (US)

(21) Appl. No.: 15/710,400

(22) Filed: Sep. 20, 2017

(51) Int. Cl. H04W 28/16; H04W 28/26; H04W 72/00; H04W 28/24

(52) U.S. Cl. CPC H04W 28/16; H04W 28/26; H04L 45/302; H04W 28/24; H04W 72/005

(57) ABSTRACT

Disclosed is a method and apparatus for enhanced availability of network-assisted services. The method may include receiving, from at least one peripheral device, one or more provisioning requests to provide service to the at least one peripheral device. The method may also include determining whether to handle one or more provisioning requests based on capabilities of the mobile gateway. Furthermore, the method may include, in response to the determination to handle the one or more provisioning requests, requesting, from a server, at least one application based on the one or more provisioning requests, wherein the at least one application enables the mobile gateway to service the at least one peripheral device.

### FIELD

This disclosure relates generally to methods, devices, and computer readable medium for enhanced network-assisted services.

### BACKGROUND

Internet connected devices may contain applications that require a connection to a server to perform certain functions. For example, the mobile device may not have enough processing power to process the data produced by an application, so the mobile device may send the data to a server for the server to process and send back to the mobile device.

In another example, the mobile device, such as a smartwatch, may have strict power constraints which prevents it from processing the data and requires the mobile device to utilize a server to perform certain functions or applications in order to reduce its power consumption.

However, in these circumstances, if the mobile device is unable to communicate with the server then the mobile device is unable to perform certain functions or execute certain applications. Additionally, utilizing a server may lead to latency issues, connection costs, etc. One limited solution that has been used in the past is “prefetching”. Prefetching allows a device to retrieve content from a server and store the content in the device's local memory so that the device may display the content on the device at a later time. Additionally, the content is the same as what would have been delivered by the server 140. While this does provide some benefit, it does not provide for rich and robust interactive services. For example, a browser application may download content from a website and store the content in device's local memory so a user may access that content when the device is no longer connected to the server.

Another solution has been used is sensor aggregation in which data is collected from multiple nearby sensors of the same type by a managing device and the leader transmits the aggregated data to a server. While this does provide some benefit, it again does not provide sufficient robust functionality. However, this does not allow for aggregation of data from different device types and/or devices from different manufacturers, because it requires complex software and/or cooperation between the different manufacturers.

### SUMMARY

An example of a method for enhanced network-assisted service may include receiving, from at least one peripheral device, one or more provisioning requests to provide service to the at least one peripheral device. The method may also include determining whether to handle the one or more provisioning requests based on capabilities of the mobile gateway. Furthermore, the method may include in response to the determination to handle the one or more provisioning requests, requesting, from a server, at least one application based on the one or more provisioning requests, wherein the at least one application enables the mobile gateway to service the at least one peripheral device.

An example of a mobile gateway for enhanced network-assisted service may include a transceiver configured to receive, from at least one peripheral device, one or more provisioning requests to provide service to the at least one peripheral device. The example mobile gateway may also include memory and one or more processors coupled to the memory and the transceiver, the one or more processors configured to determine whether to handle the one or more provisioning requests based on capabilities of the mobile gateway. Furthermore, the one or more processors may be further configured to include in response to the determination to handle the one or more provisioning requests, request, from a server, at least one application based on the one or more provisioning requests, wherein the at least one application enables the mobile gateway to service the at least one peripheral device.

An example of a mobile gateway for enhanced network-assisted service may include means for receiving, from at least one peripheral device, one or more provisioning requests to provide service to the at least one peripheral device. The mobile gateway may also include means for determining whether to handle one or more provisioning requests based on capabilities of the mobile gateway. Furthermore, the mobile gateway may include in response to the determination to handle the one or more provisioning requests, means for requesting, from a server, at least one application based on the one or more provisioning requests, wherein the at least one application enables the mobile gateway to service the at least one peripheral device.

An example non-transitory computer-readable medium for enhanced network-assisted service includes processor-readable instructions configured to cause a processor to receive, from at least one peripheral device, one or more provisioning requests to provide service to the at least one peripheral device. The processor-readable instructions configured to cause a processor to determine whether to handle one or more provisioning requests based on capabilities of the mobile gateway. Furthermore, the processor-readable instructions configured to cause a processor to include in response to the determination to handle the one or more provisioning requests, requesting, from a server, at least one application based on the one or more provisioning requests, wherein the at least one application enables the mobile gateway to service the at least one peripheral device.

### BRIEF DESCRIPTION OF THE DRAWINGS

FIG. 1 shows an example of a communication environment in which various aspects of the disclosure may be implemented.

FIG. 2 shows an example call flow diagram illustrating a method of provisioning a mobile gateway to service a peripheral device, servicing the peripheral device and reporting data back to the server.

FIG. 3 shows an example flowchart diagram illustrating a method of provisioning a mobile gateway to service a peripheral device.

FIG. 4 shows an example flowchart diagram illustrating a method of a server providing one or more applications to the mobile gateway.

FIG. 5 shows an example flowchart diagram illustrating a method of a mobile gateway servicing a peripheral device.

FIG. 6 shows an example flowchart diagram illustrating a method of a peripheral device to request service from a mobile gateway.

FIG. 7 shows an example process diagram illustrating a method of a mobile gateway determining whether to service a peripheral device or have the server service the request from the peripheral device.

FIG. 8A shows an example device of a peripheral device in which aspects of the disclosure may be implemented.

FIG. 8B shows an example device of a mobile gateway in which aspects of the disclosure may be implemented.

FIG. 8C shows an example device of a server in which aspects of the disclosure may be implemented.

### DETAILED DESCRIPTION

References throughout this specification to one implementation, an implementation, one embodiment, an embodiment, and/or the like mean that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope.

The features and advantages of the disclosed method and apparatus will become more apparent to those skilled in the art after considering the following detailed description in connection with the accompanying drawings.

Systems and techniques herein provide for an enhanced service availability for network assisted applications.

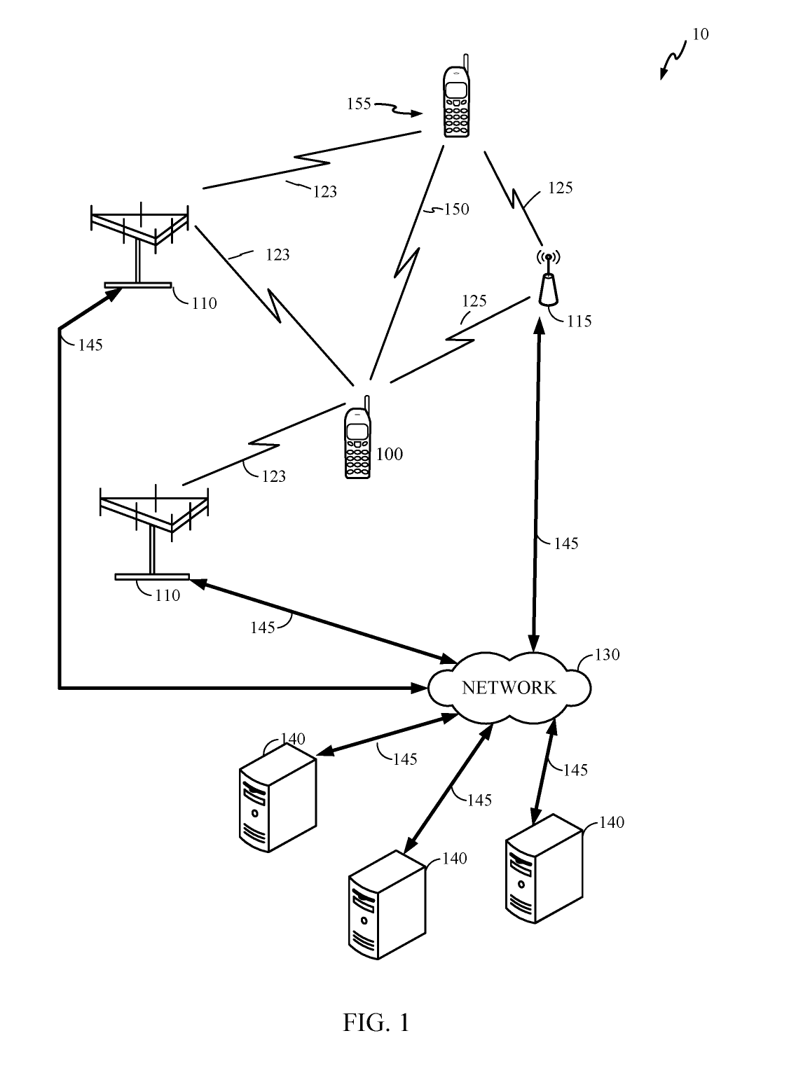

FIG. 1 shows an example of a communication environment 10 in which various aspects of the disclosure may be implemented. The mobile gateway 100 and/or peripheral device 155 may transmit radio signals to, and receive radio signals from, a wireless communication network. In one example, mobile gateway 100 may communicate with a cellular communication network by transmitting wireless signals to, or receiving wireless signals from one or more cellular transceivers 110 which may comprise a wireless base transceiver subsystem (BTS), eNodeB transceiver or an evolved NodeB (eNodeB) transceiver over wireless communication links 123. Similarly, mobile gateway 100 and/or peripheral device 155 may transmit wireless signals to, or receive wireless signals from local transceiver 115 over wireless communication link 125. A local transceiver 115 may comprise an access point (AP), femtocell, Home Base Station, small cell base station, Home Node B (HNB) or Home eNodeB (HeNB) and may provide access to a wireless local area network (WLAN, e.g., IEEE 802.11 network), a wireless personal area network (WPAN, e.g., Bluetooth® network) or a cellular network (e.g. an LTE network or other wireless wide area network such as those discussed in the next paragraph). These are merely examples of networks that may communicate with a mobile gateway over a wireless link, and subject matter disclosed and claimed herein is not limited in this respect.

Additionally, the mobile gateway 100 may communicate with the peripheral device 155 through a communication network (e.g. communication link 125 and wireless communication link 123), as described above, or it may also and/or alternatively communicate via a peer-to-peer or a mesh network (e.g. wireless communication link 150).

The mobile gateway 100 and/or peripheral device 155 may be a mobile device such as a smartphone, a tablet computer, a personal computer, a laptop or netbook, a smart watch, a head-mounted display (HMD), other wearable device, diagnostic device, or a headless (e.g. without a display) device.

The mobile gateway 100 may be a fixed device. For example, the mobile gateway 100 may be an access point/base station or collocated with the access point/base station, a device that is attached to an access point/base station, a dedicated device to function as mobile gateway, etc.

Additionally, the mobile gateway 100 may be part of a larger device or a larger system such as a router, airplane, vehicle, smart appliances, etc. In an example, the mobile gateway 100 may be collocated or embedded in a vehicle.

Examples of network technologies that may support wireless communication link 123 are Global System for Mobile Communications (GSM), Code Division Multiple Access (CDMA), Wideband CDMA (WCDMA), Long Term Evolution LTE), High Rate Packet Data (HRPD), 5G. GSM, WCDMA and LTE are technologies defined by 3GPP. CDMA and HRPD are technologies defined by the 3rd Generation Partnership Project 2 (3GPP2). WCDMA is also part of the Universal Mobile Telecommunications System (UMTS) and may be supported by an HNB. Cellular transceivers 110 may comprise deployments of equipment providing subscriber access to a wireless telecommunication network for a service (e.g., under a service contract). Here, a cellular transceiver 110 may perform functions of a cellular base station in servicing subscriber devices within a cell determined based, at least in part, on a range at which the cellular transceiver 110 is capable of providing access service. Examples of radio technologies that may support wireless communication link 125 are IEEE 802.11, Bluetooth® (BT) and LTE (e.g. LTE small cell or LTE-Direct).

In a particular implementation, cellular transceivers 110 and local transceiver 115 may communicate with servers 140 over a network 130 through links 145 or may communicate directly with servers 140 (not shown) via a peer-to-peer connection or mesh network. Here, network 130 may comprise any combination of wired or wireless links and may include cellular transceiver 110 and/or local transceiver 115 and/or servers 140. In a particular implementation, network 130 may comprise Internet Protocol (IP) or other infrastructure capable of facilitating communication between mobile gateway 100 and servers 140 through local transceiver 115 or cellular transceiver 110. In an implementation, network 130 may also facilitate communication between mobile gateway 100, servers 140. In another implementation, network 130 may comprise cellular communication network infrastructure such as, for example, a base station controller or packet based or circuit based switching center (not shown) to facilitate mobile cellular communication with mobile gateway 100. In a particular implementation, network 130 may comprise local area network (LAN) elements such as WLAN APs, routers and bridges and may in that case include or have links to mobile gateway elements that provide access to wide area networks such as the Internet. In other implementations, network 130 may comprise a LAN/WLAN and may or may not have access to a wide area network but may provide any such access (if supported) to mobile gateway 100. In some implementations network 130 may comprise multiple networks (e.g., one or more wireless networks and/or the Internet). In one implementation, network 130 may include one or more serving mobile gateways or Packet Data Network mobile gateways.

The server 140 may be a remote server, wherein the server is not in proximity with the mobile gateway 100 and/or the peripheral device 155. For example, the server may be part of a cloud server and is physically remote, in many cases hundreds or thousands of miles away from the mobile gateway 100 and the peripheral device 155.

In an implementation, the server 140 may in proximity of the mobile gateway 100 and/or the peripheral device 155. For example, the server 140 may be within hundreds of feet of the mobile gateway 100 or within range of a wide area network communication protocol, such as LTE or LTE-Direct. There may be a cost associated with connecting with the server (e.g. cost per connection or cost per duration), so having a mobile gateway 100 act on behalf of the peripheral device 155 to download one or more applications from the server 140 and then having the mobile gateway 100 service the peripheral device 155 may mitigate costs that would otherwise would have incurred if the peripheral device 155 connected to the server 140.

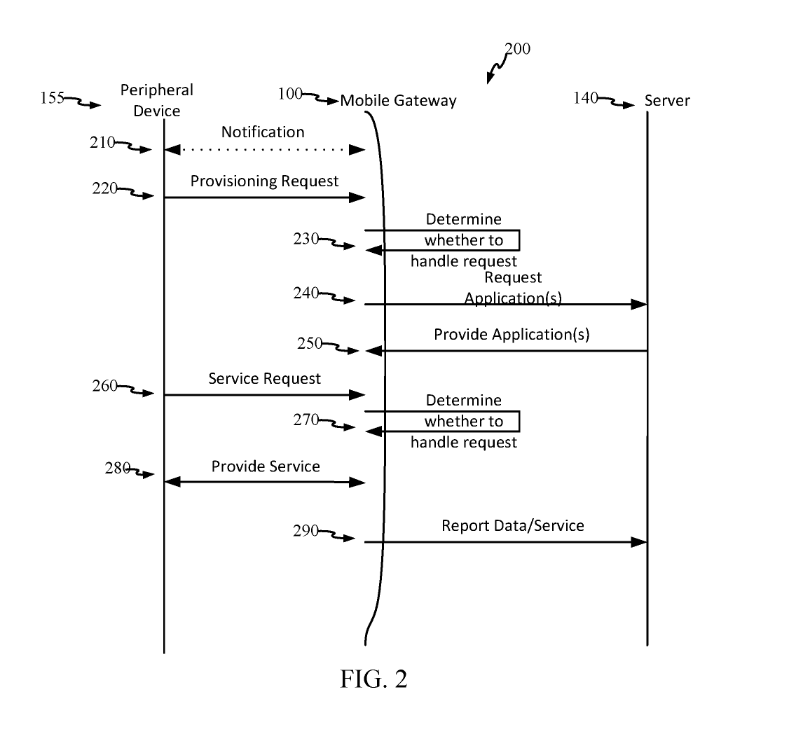

FIG. 2 is an example call flow diagram 200 illustrating a method for provisioning a mobile gateway 100 to service a peripheral device 155, servicing the peripheral device 155 and reporting data back to the server 140.

At block 210, the one or more peripheral devices 155 may notify the mobile gateway 100 of an upcoming period where the mobile gateway 100 may be in standalone mode. For example, the peripheral device 155 may be a wearable device, so the user may interact with the wearable device to indicate an upcoming period when the peripheral device 155 and the mobile gateway 100 will be in standalone mode.

Standalone mode is when the mobile gateway 100 and/or the peripheral device 155 is unable to communicate with the server 140, the connection is not stable enough or wireless wide area network (WWAN) connectivity is disabled for various reasons (e.g., power savings, rebooting WWAN functionality); however, the mobile gateway 100 and the peripheral device 155 are still functioning and are able to communicate with nearby devices via peer-to-peer connectivity (e.g. ad-hoc WLAN, WLAN Direct, Bluetooth®, LTE-Direct, etc). For example, if the mobile gateway 100 is a smartphone but it unable to communicate to a server 140 over a WAN connection (e.g. LTE), but it has local area connectivity then it may provide service to the peripheral device 155 via the local area connectivity interface (e.g. WLAN, Bluetooth®).

In another example of standalone mode, the mobile gateway 100 may enter a dead zone (e.g. lose connectivity to internet and/or server 140) or may be required to turn off their WWAN connection (e.g. during a flight). During this period, the mobile gateway 100 may be considered to be in standalone mode, and if it was provisioned prior to being in standalone mode then it may be able to service one or more peripheral devices 155 even though a connection to the server 140 is not possible at that moment.

In an implementation, the mobile gateway 100 may notify the one or more peripheral devices 155 of an upcoming standalone mode period. The notification for these implementations may be based on user input, user's content (e.g. calendar, email, etc), historical information (e.g. known dead zones), location information (e.g. current location, route destination), whether it can support one or more radio access technologies (“RAT”), whether it can support one or more RATs after a period of time or at a particular time period or at a particular location/route, whether it can support a particular band/frequency, whether it can support a band/frequency after a period of time or at a particular time period or at a particular location/route, weather conditions or any combination thereof. The peripheral devices 155 may notify the mobile gateway 100 of an upcoming standalone period similar to as described above and in other parts of the specification described herein.

In an example, the user may interact with the one or more peripheral devices 155 to trigger the one or more peripheral devices to send a provisioning request to the mobile gateway 100. In another example, the user may specify when they expect the mobile gateway 100 and/or the one or more peripheral devices to be in standalone mode, so this may trigger the one or more peripheral devices 155 to send one or more provisioning requests to the mobile gateway 100.

According to an aspect of the disclosure, the one or more peripheral devices 155 may retrieve a user's content or user's data and determine whether and/or when to send a provisioning request based on the user's content or user's data. For example, the one or more peripheral devices 155 may determine that it and/or a mobile gateway 100 will be in standalone mode because a calendar event and/or an email indicates an upcoming flight.

In an implementation, at block 210, the one or more peripheral devices 155 may determine its proximity to a mobile gateway 100 based on received signal strength (RSSI), round trip delay time (RTT), sensor data or any combination thereof, messages received from the mobile gateway or any other means, and the one or more peripheral devices 155 may use this information to determine whether to send one or more provisioning requests to the mobile gateway 100. At block 210, the one or more peripheral devices may send a notification to the mobile gateway 100 to determine if the mobile device 100 is able to handle provisioning requests and/or service requests.

In one example, a user may have one or more peripheral devices 155 when the user enters a vehicle, which has a mobile gateway 100i, but the user also has a smartphone, which also may be another mobile gateway 100j. If the smartphone mobile gateway 100 is already servicing or provisioned to service one or more peripheral devices 155 then the peripheral devices 155 may allow the smartphone mobile gateway 100 to continue servicing the peripheral devices 155. In another example, the one or more peripheral devices 155 may not be currently serviced by the smartphone mobile gateway 100 but when the user enter a vehicle the one or more peripheral devices 155 may detect the vehicle mobile gateway 100 and send one or more provisioning requests to the vehicle mobile gateway 100 and may notify the smartphone mobile gateway 100 to stop or pause servicing of the one or more peripheral devices 155.

In an implementation, at block 210, the mobile gateway 100 may determine its proximity to a peripheral device 155 based on RSSI, RTT, sensors, or messages received from the peripheral device or any other means, and the mobile gateway 100 may use this information to notify the peripheral device 155 of the proximity and may indicate whether the mobile gateway 100 is able to handle provisioning requests and/or service requests from the peripheral device 155.

At block 220, the one or more peripheral devices 155 may send at least one provisioning request to the mobile gateway 100. The at least one provisioning request may comprise an identifier of the peripheral device, priority level, urgency level, service type, quality of service (QoS), service requirements, duration request, provisioning request start time, provisioning request end time, location/route, connection priority or any combination thereof.

In an implementation, the provisioning request may include a priority level that indicates the peripheral device's priority and/or the provisioning requests priority from multiple requests made by the peripheral device. For example, the peripheral device 155 and the mobile gateway 100 may be owned by the same person or entity, so the peripheral device 155 may notify the mobile gateway 100 that its provisioning requests have the highest priority level. In another example, the peripheral device 155 may request multiple services from the mobile gateway and provide a priority level to each of the services so the mobile gateway 100 may determine which service is a higher priority to the peripheral device 155.

According to an aspect of the disclosure, the provisioning request may include an urgency level that indicates the urgency of the provisioning request. For example, the provisioning request may be from a blood pressure device with the service being receiving data from the blood pressure device, processing the data by the mobile gateway 100 and the mobile gateway 100 determining how to adjust an insulin pump. In this case, the provisioning request may indicate that the urgency level is life threatening or high and the mobile gateway may use this to determine whether it can handle this request.

In an implementation, the provisioning request may include a service type which may comprise: health services, wellness services, fitness services, coordinating services, gaming services, processing/computing services, sensor calibration services, controller/configuration services, scheduling service, positioning service, aggregating services, imaging service or any combination thereof.

For example, there may be multiple peripheral devices 155 attached to a user (e.g. smartwatch, HMD, smart clothing including biometric sensors, etc) along with the user's smartphone, which acts as a mobile gateway 100. The peripheral devices 155 may send data to the mobile gateway 100 to coordinate activities between each of the peripheral devices 155. In one example, the peripheral devices 155 may be coordinated to determine how a user reacts to a particular situation, such as the user is sitting in traffic and the device triggers measurements, via the user's smart clothing biometric sensors, to determine the user's heart rate. In another example, there may be cameras in the HMD and the smartwatch so the smartphone may be coordinating image captures to determine what is around the user to provide the user with navigation and/or location based services.

Additionally, the provisioning request may include QoS requirements. For example, the provisioning request may specify latency requirements when the mobile gateway 100 is servicing a request so the mobile gateway 100 needs to determine whether it can handle that latency requirements in light of the mobile gateway's 100 constraints and service commitments already scheduled for the mobile gateway 100.

In an implementation, the provisioning request may include cost requirements. For example, it may specify connection costs, server costs, etc. This may be beneficial for situations where the mobile gateway 100 may be able to establish a connection with a server 140, but may not want to do so because of the cost requirements.

According to an aspect of the disclosure, the provisioning request may include time period requirements. For example, it may specify that a mobile gateway 100 should handle a request when the network and/or server during on peak hours but should communicate over the network and/or the server when it is off peak hours.

The provisioning request may include a duration for how long the mobile gateway 100 needs to be available to service the request. For example, the peripheral device 155 may notify the mobile gateway 100 of an upcoming flight, which will cause the mobile gateway 100 to go into standalone mode so the peripheral device 155 may request service for the duration of the flight.

In an implementation, the provisioning request may include a service start time and/or end time. For example, the peripheral device 155 may notify the mobile gateway 100 of an upcoming flight start time, so it may request service start at the flight start time so it doesn't need to start the service immediately. In another example, the peripheral device 155 may request that the mobile gateway 100 start the service immediately but may provide the mobile gateway 100 with an end time (e.g. flight arrival time) of when to stop the service.

The provisioning request may indicate a persistent connection with the mobile gateway 100 and the mobile gateway determines whether to process the request or forward the request to a server 140. The peripheral device 155 contacts the mobile gateway 100, but the mobile gateway 100 determines whether to provide service at that specific time, delay it or forward the request on to the server 140. This allows the peripheral device 155 to be unware of the server 140 involvement and the peripheral device 155 would not have to handle latency problems or whether the connection with the server 140 randomly drops out. The provisioning request may also not have to specify duration, start/end time, etc.

In an implementation, the provisioning request may indicate a location or a route when the mobile gateway 100 should service the peripheral device 155. For example, the provisioning request may indicate that the mobile gateway 100 may provide service to the peripheral device 155 only while the peripheral device 155 is at the user's home. In another example, the mobile gateway 100 may be in or collocated with vehicle so a provisioning request may indicate that the peripheral device 155 would like service during a portion of a vehicle's route. The location and/or route may be determined by the mobile gateway 100 and/or the peripheral device 155. The location and/or route may be determined with one or more location servers in conjunction with the mobile gateway 100 and/or the peripheral device 155.

According to an aspect of the disclosure, the provisioning request may indicate a connection priority when there may be multiple mobile gateways 100. For example, the provisioning request may indicate that when a mobile gateway 100 that is embedded or collocated with a vehicle then the peripheral device 155 may connect to the vehicle while the peripheral device 155 is in proximity with the vehicle; however, when the peripheral device 155 is no longer in proximity with the vehicle then the provisioning request may indicate the peripheral device 155 may be serviced by a second mobile gateway 100 that is the user's smartphone, embedded in the user's smartphone or collocated with the user's smartphone.

The provisioning request may include the device type of the peripheral device 155. For example, the peripheral device 155 may notify the mobile gateway 100 that the peripheral device 155 is a glucose monitor. This may be used to determine priority between provisioning requests.

Additionally, the device type may be used to determine services that may be available. In an implementation, if the device type of the peripheral device 155 and the mobile gateway 100 are the same or similar it may have a limited set of services but if the mobile gateway 100 has additional capabilities compared to the peripheral device 155 then there may be a large set of services that are available. For example, if the mobile gateway 100 is embedded or collocated with a vehicle and the peripheral device 155 is a smartphone then the services available may include data aggregation, but if the mobile gateway 100 and the peripheral device 155 are the same or similar type of device (e.g. a smartphone) then the service of data aggregation may not be available.

The one or more peripheral devices 155 may determine whether to send one or more provisioning requests to a mobile gateway 100 based on historical information of the peripheral device 155, an indication that the mobile gateway 100 may enter standalone mode at an upcoming time period, the proximity to a mobile gateway 100 or any combination thereof.

As an example, the one or more peripheral devices 155 may determine a mobile gateway 100 is needed for various portions of the one or more peripheral device's 155 route based on historical patterns. For example, the one or more peripheral device 155 may have a route to work but experiences a service outage for a portion of the route so utilizing a mobile gateway 100 for that portion of the route might benefit the one or more peripheral devices 155.

In another example, the one or more peripheral devices 155 may determine that utilizing a WWAN connection drains the one or more peripheral devices 155 battery and it is only able to function for a subset of the needed duration based on historical information. The one or more peripheral devices 155 may detect that a smartphone, which can function as a mobile gateway 100, is usually collocated or in proximity with the one or more peripheral device 155 for at least a portion of a duration that the one or more peripheral devices 155 is needed. This allows the one or more peripheral devices 155 to communicate over a wireless connection that utilizes less power, such as WLAN or Bluetooth® Low Energy (BLE).

The mobile gateway 100 or another device may perform functions such as determining when the one or more peripheral devices 155 should send one or more provisioning requests to the mobile gateway 100 and it may provide data to the one or more peripheral devices 155 that can cause the one or more peripheral devices 155 to send one or more service requests or the one or more peripheral devices 155 may use this information to determine whether to send the one or more provisioning requests.

At block 230, the mobile gateway 100 determines whether it can handle at least one provisioning request from the one or more peripheral devices. The mobile gateway 100 may determine whether it can handle the at least one provisioning request based on capabilities of the mobile gateway 100, constraints of the mobile gateway 100, constraints caused by servicing the at least one provisioning request, or any combination thereof.

The mobile gateway 100 may determine whether it has the capabilities to service the at least one provisioning request. It may identify whether the mobile gateway 100 has sufficient processing capabilities, reception and/or transmission capabilities, storage capabilities, security requirements, etc. For example, the mobile gateway 100 may determine that the at least one provisioning request requires a certain number of processing cycles within a given period and compare the requirement to processor capabilities of the mobile gateway 100.

In an implementation, the mobile gateway 100 may determine whether it can handle the provisioning request based on the constraints of the mobile gateway 100. For example, it may determine whether the mobile gateway 100 has sufficient storage space, available power, sufficient processing availability, etc.

The mobile gateway 100 may determine whether it can handle the provisioning request based on the constraints that may be caused by handling the provisioning request. For example, it may determine whether to handle the provisioning request based on the provisioning request causing battery consumption to increase by 1 mA-hours.

In another example, the at least one provisioning request may indicate a service type, the mobile gateway 100 may request from a server 140 processing requirements based on the service type and the mobile gateway 100 may determine whether it can handle the processing requirements based on its capabilities. In one example, after receiving the service type in the at least one provisioning request, the mobile gateway 100 may request from a server 140 one or more functions, which may also be one or more applications or a subset of the application, and test data to allow the mobile gateway 100 to evaluate whether it has the capabilities necessary to handle the at least one provisioning request. The one or more functions may be test functions or may be actual functions that can be utilized in servicing the at least one provisioning request.

The mobile gateway 100 may evaluate the at least one provisioning requests based on various components within the mobile gateway 100. For example, the at least one provisioning request may require a digital signal processor (DSP) and the mobile gateway 100 may accept or deny the at least one provisioning request based on whether the mobile gateway 100 has a DSP.

In an implementation, the mobile gateway 100 determines whether to handle at least one provisioning request based on the constraints of the mobile gateway 100. The constraints may comprise current or historical usages of the device, resource commitments (such as processing commitments (e.g. DSP, GPU, CPU, etc), storage commitments, transmission/reception commitments, peripheral components usages, etc), battery commitments, or any combination thereof.

According to an aspect of the disclosure, the mobile gateway 100 may use the current and historical usages of the mobile gateway 100 to determine whether it can handle at least one provisioning request from the one or more peripheral devices 155. For example, the mobile gateway 100 may be a smartphone, so it may need to determine how the user uses the smartphone to determine if the smartphone will be able to function as a mobile gateway 100 for the peripheral devices. It may look at how many processing cycles are available in light of how the user uses the device, the storage levels available on the smartphone and/or how much battery life is needed for typical smartphone usage by the user. One of the benefits of this approach is attempting to minimize the drawbacks of allowing a smartphone to be a mobile gateway (e.g. running out of battery during typical usage) but also allowing the peripheral devices, which may be the users, to reduce service outages, latency issues, etc.

In an implementation, the resource commitments of the mobile gateway 100 are used to determine whether the mobile gateway 100 can handle at least one provisioning request. These resource commitments may be commitments required to handle local processes, such as a user playing a game on a smartphone that may also be used as a mobile gateway, and/or may be commitments related to other provisioning requests that the mobile gateway has already accepted. In one example, the provisioning request may be to aggregate data from the one or more peripheral devices, process the data and generate calibration data for sensors on the one or more peripheral devices and the mobile gateway may be already be handling a gaming service with a second peripheral device, so it needs to determine whether it is able to generate calibration data within any restrictions that are included in the provisioning request while also handling the gaming service it has already committed to handling.

The mobile gateway 100 may use its battery level, battery capacity and/or battery usage to determine whether to handle at least one provisioning request from the one or more peripheral devices 155. In one example, the mobile gateway 100 (e.g. smartphone) may have a current battery level of 50% and a user's historical usage patterns suggest that by the end of the day there will only be 10% of the total battery's capacity left; however, the provisioning request will only need 1-2% of the total battery capacity for the duration of the requested period, so the mobile gateway 100 may accept this provisioning request.

Additionally, in an implementation, the mobile gateway 100 may decide on each and every provisioning request regardless of the order in which the provisioning request is received. For example, the mobile gateway 100 may receive three provisioning requests at a similar time and the mobile gateway 100 may accept the first request, reject the second request and accept the third request. As a result, the mobile gateway 100 may determine whether to handle one or more services requests from the at least one provisioning requests.

The benefit of a mobile gateway 100 determining whether to handle one or more provisioning requests from the at least one provisioning requests is it allows the mobile gateway 100 to determine how to maximize its resources without forcing a mobile gateway 100 to comply or needing to build a dedicate network of mobile gateways 100.

At block 240, if the mobile gateway 100 has determined whether to handle one or more provisioning requests from the at least one provisioning request then the mobile gateway 100 may send a request to a server 140 to retrieve one or more applications that correspond to servicing the one or more peripheral devices associated with the one or more provisioning requests.

According to an aspect of the disclosure, the one or more applications that run on the server 140 are the same applications that are provided to the mobile gateway 100.

In an implementation, the one or more applications may be a portion of a large application that runs on a server 140. For example, the service provided to the peripheral devices 155 from the server 140 may comprise a plurality of applications, but the mobile gateway 100 may receive a portion of those applications to provide service.

In an implementation, the one or more applications may be different from the applications that are running on a server 140. As an example, the one or more applications may be specifically designed for similar mobile gateways, processor instruction set, etc.

For example, the one or more applications may be designed for smartphone mobile gateways that have similar specifications but a different set of applications for vehicle mobile gateways. In another example, the one or more applications may be designed for x86/x64 instruction set on the server 140, but the mobile gateway is based on an ARM instruction set so the different set of applications may be designed for the ARM instruction set. In another example, the one or more applications may be designed for a larger power envelope device (e.g. device with power outlet) but may different applications for a smaller power envelope device (e.g. wearable device with limited power).

In an implementation, the mobile gateway 100 may receive functions or portions of one or more applications. For example, the server 140 may need to run one application to service the peripheral device 155, but the mobile gateway 100 receives a portion of the application. The mobile gateway 100 may run the application or a portion of the application via a virtual environment. In another example, the mobile gateway 100 may receive an application or a portion of an application and compile the code on the mobile gateway 100 prior to running it. In another example, the mobile gateway 100 may receive an application or a portion of an application and the mobile gateway 100 may be able to use an interpreter to run the application without having to compile it.

The mobile gateway 100 may send a request to the server 140 indicating the service it intends to provide to the one or more peripheral devices 155, but it may not be aware of the exact applications that are needed. In this circumstance, the server 140 determines which applications are applicable based on the services the mobile gateway intends to provide.

The server 140 may further determine which applications are applicable based on the mobile gateway's capabilities, the mobile gateway's constraints or any combination thereof. For example, rather than provide an application that can fully service the needs of a peripheral, the server 140 may determine the application would consume too much power from the mobile gateway so it may send a subset of the application or a different application that provides a limited amount of functionality that is not as complete as what is being provided by the server 140.

The request to the server 140 may include credentials, service duration, service start/end time or any combination thereof. For example, the credentials may be one or more temporary credentials received from the one or more peripheral devices 155 and provided by mobile gateway 100 to the server 140 so the server can identify which peripheral devices the mobile gateway 100 may be servicing along with when and how long it may be available to provide service to those devices.

In an implementation, the credentials may be an identifier, one or more keys, password, or any combination thereof that allows the server 140 to determine the validity of the request from the mobile gateway 100. For example, the mobile gateway 100 may indicate it is attempting to provide service to a peripheral device; however, if the incorrect credentials are provided the server should not provide the application and/or data applicable to the peripheral device to the mobile gateway 100. The credentials may be transferred in various secure ways as known in the art. The credentials may be at least partially stored on a physical key, such as a SIM card or SD card.

Furthermore, the mobile gateway 100 may provide the service duration, service start time, service end time or any combination thereof. This information may be the same or similar to what is provided by the peripheral device when it sends a provisioning request and/or a service request to the mobile gateway 100 or it may be determined by the mobile gateway 100 based on the provisioning request, the service request, the mobile gateways current commitments or any combination thereof.

In an implementation, after the server 140 has processed the request from the mobile gateway 100, at block 250, the server 140 may send the one or more applications along with peripheral device data. For example, the peripheral device data may be specific to the peripheral device and/or user such as configuration information based on historical information of the device and/or the user. In another example, the peripheral device data may be device type specific, such as calibration data based on the device's model number, manufacturer, software version, device type (e.g. smartphone, smart watch) etc.

According to an aspect of the disclosure, the peripheral device data may be manufacturer and/or service operator specific. For example, the data may be applicable to all devices from the manufacturer or any device that utilizes a particular service.

In an implementation, the peripheral device data may be any combination listed above. For example, it may include user specific data, device type data and service operator data.

The server 140 may indicate what report data it would should receive back from the mobile gateway 100, when it should receive that data back, what the mobile gateway 100 should do with the report data after it is sent to the server 140, or any combination thereof.

The server 140 may indicate that the mobile gateway 100 should store the data it receives and provides to the peripheral device 155, store data (such as calibration data, aggregated data), store the last data provided to and/or received from the peripheral devices, generate report data based on what is provided/received, or any combination thereof. For example, the mobile gateway 100 may generate a report that has timestamps of when service was provided and service type and it may also store the last data provided and/or received from the peripheral device, and the mobile gateway 100 may send the report and the stored data to the server 140.

The server 140 may indicate that the mobile gateway 100 should report data to the server 140 periodically, non-periodically, at specific times (e.g. specific times/dates during a day, week, month), when the mobile gateway 100 has reliable connection or any combination thereof. For example, the server 140 may indicate that data should be sent to the server every hour but may want to be informed after calibration data has been sent to the peripheral device two times and it may ask it to send data to it only when the mobile gateway 100 has a reliable connection to the internet and/or server 140.

The server 140 may indicate that after the mobile gateway 100 transmits the data to the server then the gateway should keep the data, remove all the data, delete a subset of the data, filter the data, generate new data or any combination thereof. For example, the mobile gateway 100 may generate data that indicates the report data was sent to the server 140 and the mobile gateway 100 may delete the report data.

At block 260, the one or more peripheral device 155 may send a service request to the mobile gateway 100. The service request may include service type, data requested or any combination thereof.

The service data request may include a service type. In some implementation, the service type is provided when there are multiple services running to provide service to the requesting peripheral device 155. For example, the mobile gateway 100 may be running one service that deals with gaming and a second service dealing with aggregation for the requesting peripheral device 155, so the service type may be used to specify which service it is requesting at that time.

The service type may be used when there is one service running for the requesting peripheral device 155; however, there may have multiple services built into the same service. For example, the mobile gateway 100 may be running an aggregation service for the requesting peripheral device 155; however, it may also include compression and filtering services built into the aggregation service so the service type may specify if it is limited to aggregation, filtering and/or compression.

The data request may specify what data the requesting peripheral device 155 wants from the mobile gateway 100. For example, the mobile gateway 100 may be running a service dealing with calibration of sensors located on the requesting peripheral device 155, and the data request may specify which sensor from the plurality of sensors it would like calibration data. In a similar example, rather than sending the entire calibration data it may include what has changed from the last time the requesting peripheral device has requested calibration data for a particular sensor and send the differential calibration data.

At block 260, the mobile gateway 100 may request data from the peripheral device 155 about the time of service (e.g., when it is time for the peripheral device 155 to be serviced). This request from the mobile gateway 100 may be based on a periodicity or non-periodic threshold that was provided in the provisioning request or determined based on the provisioning request, may be based on particular criteria that was provided in the provisioning request or any combination thereof. For example, the provisioning request may indicate that the mobile gateway 100 should request data or the peripheral device 155 may send data at the specified periodicity.

According to an aspect of the disclosure, the provisioning request may include criteria for when to request data or when the peripheral device 155 should provide data. For example, the mobile gateway 100 may indicate that the peripheral device 155 should provide data at a periodic rate at a certain start time, and it may also indicate the peripheral device 155 can start requesting data from the mobile gateway 100 starting at a certain time. The criteria may be based on a threshold of various data (such as power levels).

At block 270, the mobile gateway 100 may generate a response based on the service request. The response may be the requested data, data associated with the requested service or it may be an acknowledgement indicating the service request has been processed.

According to an aspect of the disclosure, even though the mobile gateway 100 may be provisioned to service a request from the requesting peripheral device, the mobile gateway 100 may deny a service request from the requesting peripheral device based on battery level of the mobile gateway 100, urgency commitments of the mobile gateway 100, commitment prioritization, overriding parameter, or any combination thereof.

For example, the mobile gateway 100 may deny a provisioned service request if the battery level of the mobile gateway 100 drops below a threshold. The mobile gateway 100 may have reserved a portion of the battery (e.g. 3300 milliamp-hour) for emergency services associated with a peripheral device 155, so when the battery level drops to 3300 milliamp-hour the mobile gateway 100 may deny any request that is not associated with the emergency service.

In another example, the mobile gateway 100 may determine that it is only able to handle requests that are urgent, so it may allow service requests that are marked urgent and deny others. This may be done for various purposes. In one example, the mobile gateway 100 is a smartphone and the user is playing a game on their smartphone that takes a large portion of the smartphone's processing capabilities so it may need to keep the rest of the smartphone's processing capabilities reserved for urgent requests, such as healthcare services, until the smartphone has recovered some of its processing resources.

In an additional example, the mobile gateway 100 may have its commitments prioritized, so it can keep a portion of its resources reserved for some services. For example, the mobile gateway 100 may have high commitment priority for blood glucose measurements from the peripheral device 155 but it is currently servicing lower priority commitments, so it may reserve resource for the blood glucose measurements rather than process a service request from a low priority commitment.

At block 280, the mobile gateway 100 will provide the requested service to the one or more peripheral devices 155 based on the service request and/or the provisioning request.

At block 290, the mobile gateway 100 may generate and/or provide data to the server 140 based on the information that was requested by the server 140 when it provided the application and/or peripheral data.

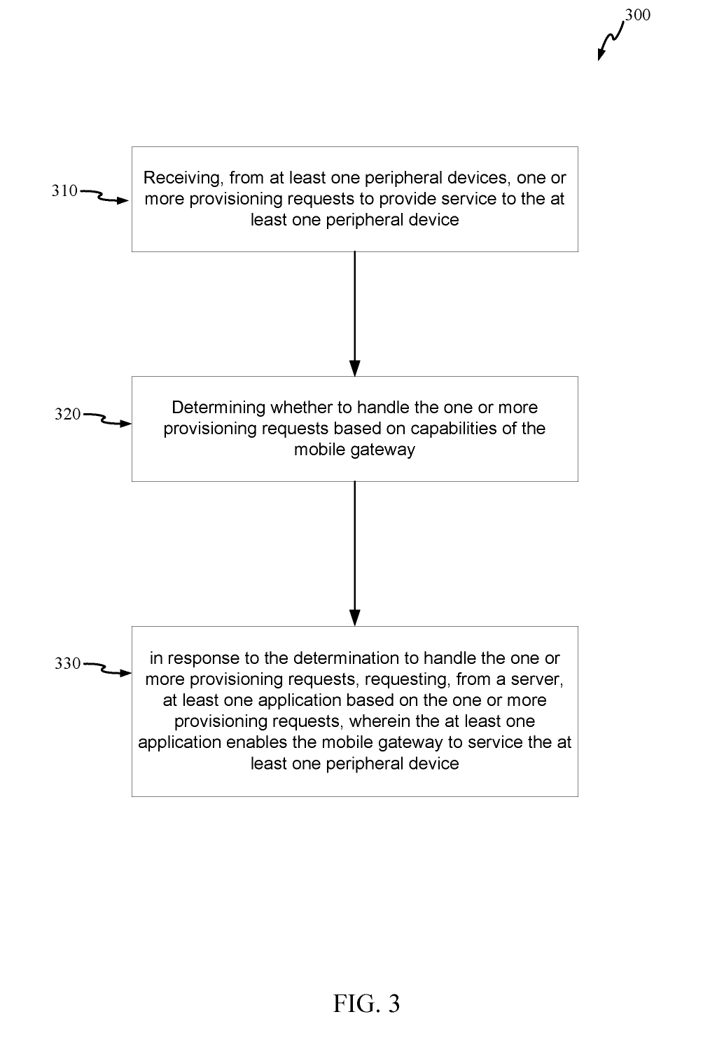

FIG. 3 is an example flowchart diagram 300 illustrating a method for provisioning a mobile gateway 100 to service a peripheral device 155. In an implementation, this process may occur after the mobile gateway and/or peripheral device has received an indication for the need to provision the mobile gateway. For example, this may be done based on the user's input, an upcoming period of the mobile gateway being in standalone mode, an upcoming period of the peripheral device being in offline mode (e.g. no longer communicating with a server 140 or no longer using WWAN connectivity, etc.).

At block 310, the mobile gateway 100 receives, from one or more peripheral devices, at least one provisioning request. The provisioning request may comprise various elements and/or aspects as described in block 220 above and/or in this specification.

At block 320, the mobile gateway 100 determines whether to handle the at least one provisioning request based on capabilities of the mobile gateway and constraints of the mobile gateway. This determination is further described in block 230 and/or in this specification. Means for performing the functionality at block 320 can include, for example, the processor unit 841, and/or memory 844. The mobile gateway 100 may determine whether to handle the at least one provisioning request based on capabilities of the mobile gateway, constraints of the mobile gateway or any combination thereof.

At block 330, in response to determining to handle one or more provisioning requests from the at least one provisioning requests, transmitting an application request to a server 140 for one or more applications that correspond to servicing the at least one peripheral device. This transmitting an application request is further described in block 240 and/or in this specification.

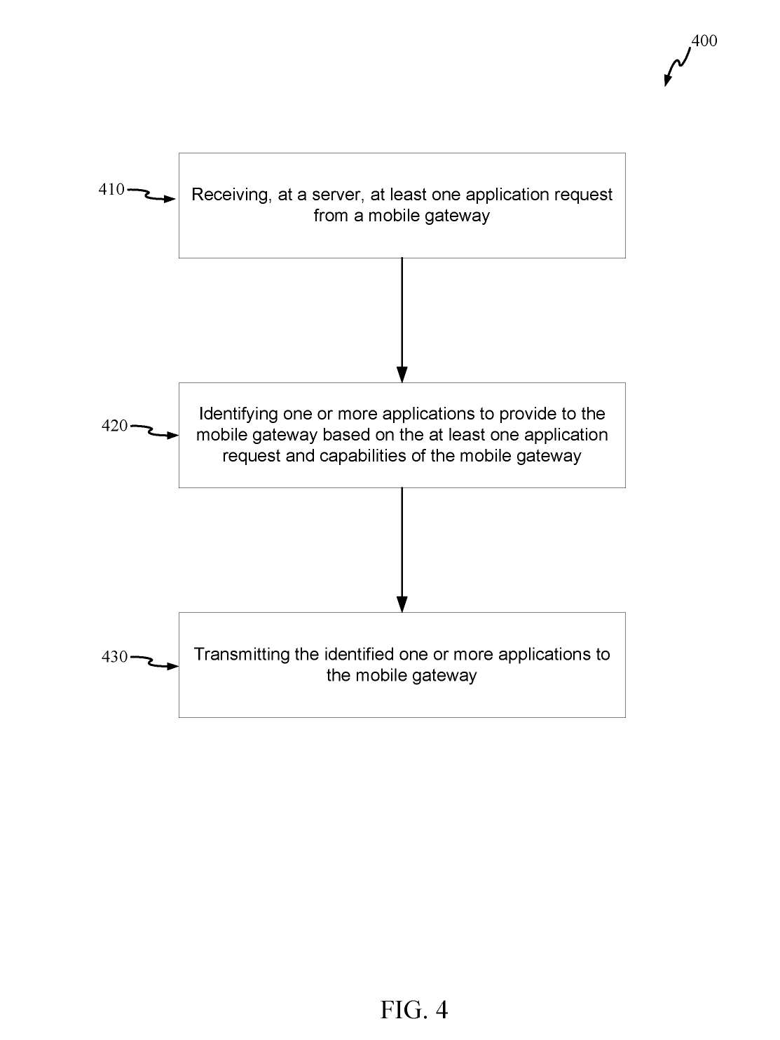

FIG. 4 is an example flowchart diagram 400 illustrating a method of a server 140 providing one or more applications to the mobile gateway 100.

At block 410, a server 140 receives at least one application request from a mobile gateway 100. The application request is further described in block 240 and/or in this specification.

At block 420, the server 140 identifies one or more applications to provide to the mobile gateway based on the at least one application request and capabilities of the mobile gateway. In an implementation, the server 140 identifies the one or more applications based on the application request. For example, the application request may include the application name/identifier, service request needs, etc. Specifically, the application request may include a service need such as blood pressure calibration for the peripheral devices and the server 140 may identify applications that fit that need and may narrow it down based on additional information, such as a need for a medical grade application and/or algorithm, or provide the best fit. This is further described in block 240 and/or in this specification.

At block 430, the server 140 transmits the identified one or more applications to the mobile gateway 100. This is further described in block 250 and/or in this specification.

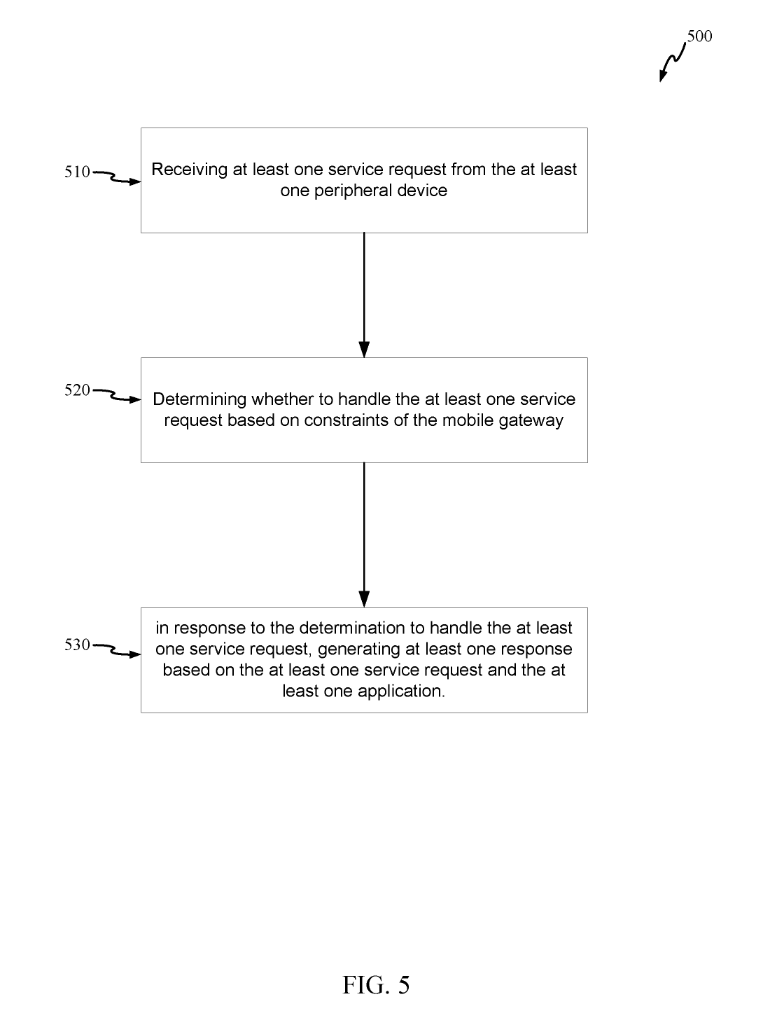

FIG. 5 is an example flowchart diagram 500 illustrating a method of a mobile gateway 100 servicing a peripheral device 155. This example call flow may occur after the mobile gateway 100 has already been provisioned (e.g. accepted a provisioning request from or on behalf of the peripheral device 155) to service the peripheral device 155.

At block 510, the mobile gateway 100 receives at least one service request from one or more peripheral devices 155. This is further described in block 260 and/or in this specification.

At block 520, the mobile gateway 100 determines whether to handle the at least one service request based on constraints of the mobile gateway 100. This is further described in block 270 and/or in this specification.

At block 530, in response to the determination to handle the at least one service request, the mobile gateway 100 generates at least one response based on the at least one service request and the at least one application. In an implementation, service is provided to the one or more peripheral devices based on the determination to handle the at least one service request. The service that is provided may comprise messages between the mobile gateway 100 and the peripheral device (e.g. to the peripheral device and/or from the peripheral device). This is further described in block 280 and/or in this specification.

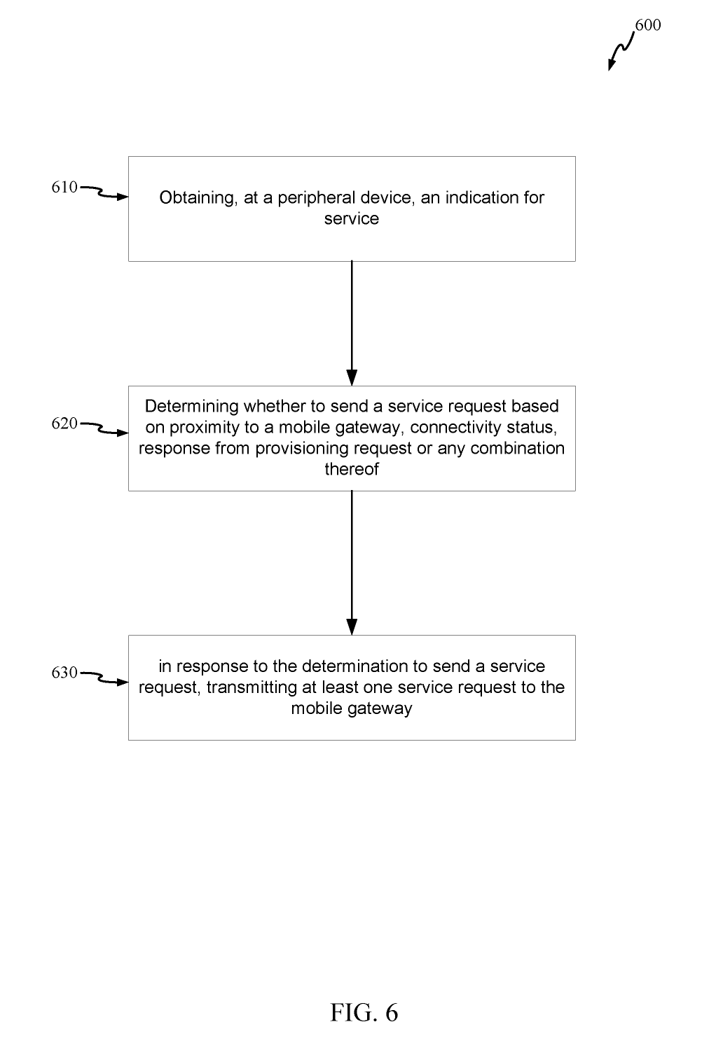

FIG. 6 is an example flowchart diagram 600 illustrating a method of a peripheral device 155 to request service from a mobile gateway 100.

At block 610, the peripheral device may obtain an indication for service. For example, the indication may be user input, email content, calendar, etc. This is further described in block 210 and/or in this specification.

At block 620, the peripheral device may determine whether to send a service request based on proximity to a mobile gateway, connectivity status, response from a provisioning request or any combination thereof.

The peripheral device 155 may send a service request based on its connectivity status. For example, the peripheral device may have internet service or is able to communicate with the server, so it won't send the service request to the mobile gateway 100. In another example, if the peripheral device does not have WWAN connectivity functionality but it is able to communicate with a mobile gateway 100 then it can send a service request to the mobile gateway 100.

The peripheral device 155 may send a service request based on a response from a mobile gateway 100 that indicates that it has accepted the provisioning request and has been provisioned to service the peripheral device 155.

At block 630, in response to the determination to send a service request, transmitting at least one service request to the mobile gateway. The service request is further described in block 260 and/or in this specification.

According to an aspect of the disclosure, if the determination is to not send a service request, the peripheral device may store data to be serviced at a later point in time, when the mobile gateway is able to service the request, or the peripheral device is able to communicate (directly or through one or more intermediaries) with the server 140.

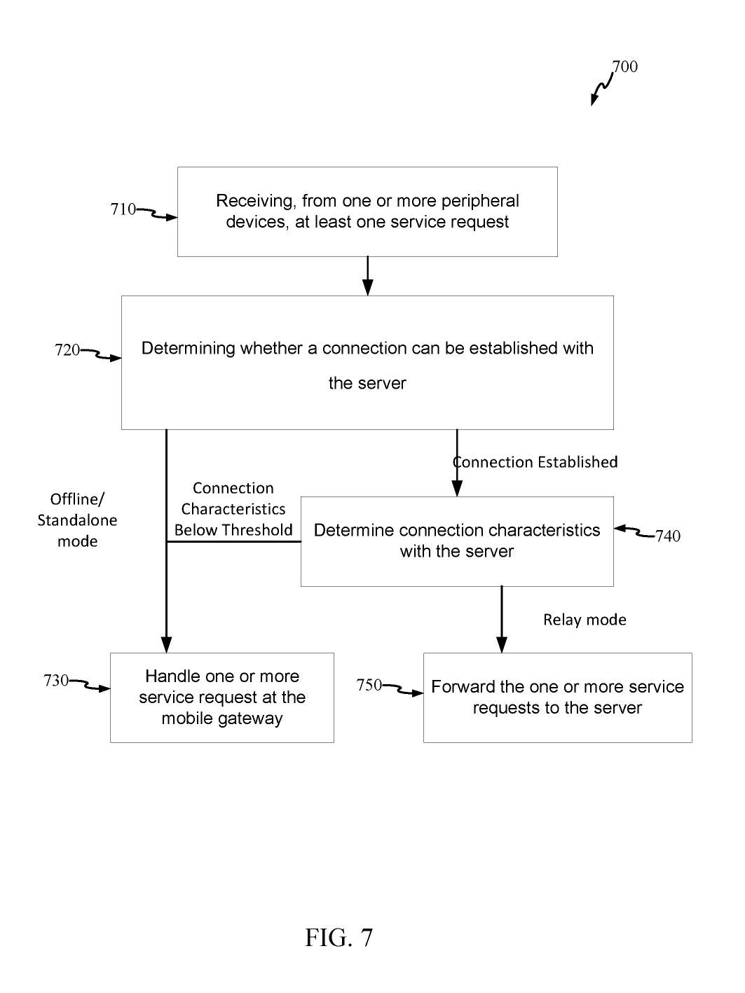

FIG. 7 is an example process diagram 700 illustrating a method of a mobile gateway 100 determining whether to service a peripheral device 155 or have the server 140 service the request from the peripheral device 155. This example flowchart may occur after the mobile gateway 100 has already been provisioned (e.g. accepted a provisioning request from or on behalf of the peripheral device 155) to service the peripheral device 155.

At block 710, the mobile gateway 100 receives at least one service request from one or more peripheral devices.

At block 720, the mobile gateway 100 determines whether it can establish a connection with the server 140. If the mobile gateway 100 determines it cannot establish a connection with a server 140 or determines there is an upcoming standalone period (e.g. deadzone, airplane mode, etc), it proceeds to block 730. Otherwise, it proceeds to block 740.

At block 730, the mobile gateway 100 may handle one or more service requests from the one or more peripheral devices 155, while the mobile gateway 100 is standalone mode.

In an example, the peripheral device 155 may be a smartphone and the mobile gateway 100 may be a vehicle or collocated with the vehicle. The smartphone may have a gaming application that requires a connection to server 140 for processing, so the vehicle may be provisioned to have an application that allows it to take over some functionality of the server 140 so that the gaming application is uninterrupted for the user of a smartphone even when the vehicle enters various dead zones along the route.

In another example, the peripheral device 155 and/or the mobile gateway 100 may predict that a standalone mode period may be occurring in the future based on historical information, calendar events, location information, user input, crowdsourced information or any combination thereof.

At block 740, the mobile gateway 100 determines one or more connection characteristics for the connection with the server 140. The mobile gateway may evaluate the connection with the server 140 based on various characteristics such as throughput, latency, connection stability, time of day (e.g. peak vs non-peak for network and/or server), connection cost (e.g. network connection cost, server costs), QOS, length of connection, guarantee of connection (e.g. time), security requirements or any combination thereof.

The mobile gateway 100 may determine that one or more connection characteristics to the server 140 do not meet one or more thresholds, so it proceeds to block 720 as if the mobile gateway 100 were in standalone mode. For example, the mobile gateway 100 may determine that the connection with the server 140 intermittently goes out, the latency to the server is too high and/or the data throughput to the server is not high enough. These are some examples of characteristics that may be used to determine whether the connection between the mobile gateway 100 and the server 140 is deemed to be unstable. If it determines the connection is not stable, then the mobile gateway may proceed as if it is in standalone mode.

When the connection characteristics indicate a good connection to the server 140 and/or exceeds the one or more thresholds, process proceeds to block 440.

At block 750, the mobile gateway 100 may forward the service request to the server 140 on behalf of the one or more peripheral devices 155 and receive the one or more responses from the server 140 and forward the one or more responses to the one or more peripheral devices 155.

The mobile gateway 100 may generate a one or more server requests to the server 140 based on the one or more service requests from the peripheral devices and the one or more applications. This allows the mobile gateway 100 to selectively transmit the server requests based on the connection characteristics as indicated in block 740. When the mobile gateway 100 transmits the server requests it is considered to be in relay mode. The relay mode may be server requests based at least on the service request or it may simply forward the service request.

In an implementation, when the mobile gateway 100 is in relay mode (e.g. forwards the service request to the server 140 and sends data from the server 140 to the peripheral device) the application layer on the mobile gateway 100 may be bypassed and a lower layer, such as the communication layer, may relay data between the peripheral devices 155 and the server 140. The mobile gateway 100 may bypass the processor unit 841 and utilize the network interface 830.

In an implementation, once the connection characteristics indicate a good and/or strong connection to the server 140 the mobile gateway 100 may notify the one or more peripheral devices 155 that a connection to the server 140 is available so that the one or more peripheral devices 155 may establish a connection to the server 140 without using the mobile gateway 100 any further.

The mobile gateway 100 may have one or more applications that preprocess the data from the service request and then sends the preprocessed data and/or a portion of the service request to the server 140. This enables the server 140 to handle the request faster and may reduce bandwidth requirement for sending the data and/or the request to the server 140.

The mobile gateway 100 may have one or more applications that postprocess data received from the server 140 in response to the service request and sends the processed data to the one or more peripheral devices 155.

The implementations described in this application offer various benefits. A few examples include: it reduces latency, processing requirements, costs, allows for diverse device types, allows for devices from different manufacturers, enables new service operators and thus new business opportunities, allows reduced hardware and software complicity in the peripheral devices for transitioning between server connectivity and mobile gateway connectivity, etc.

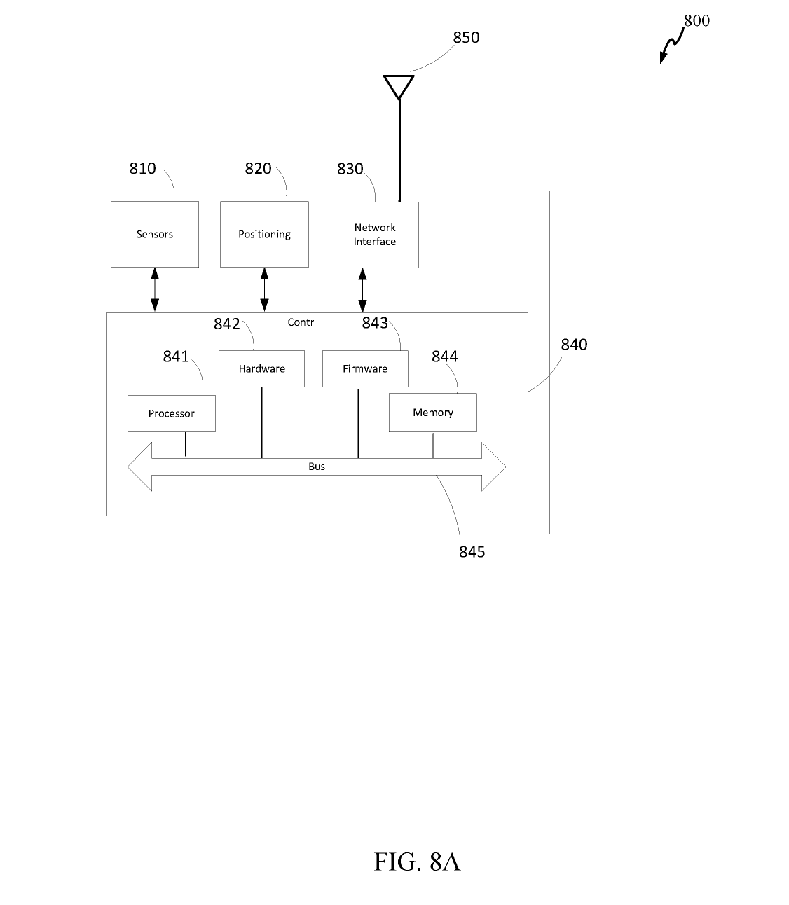

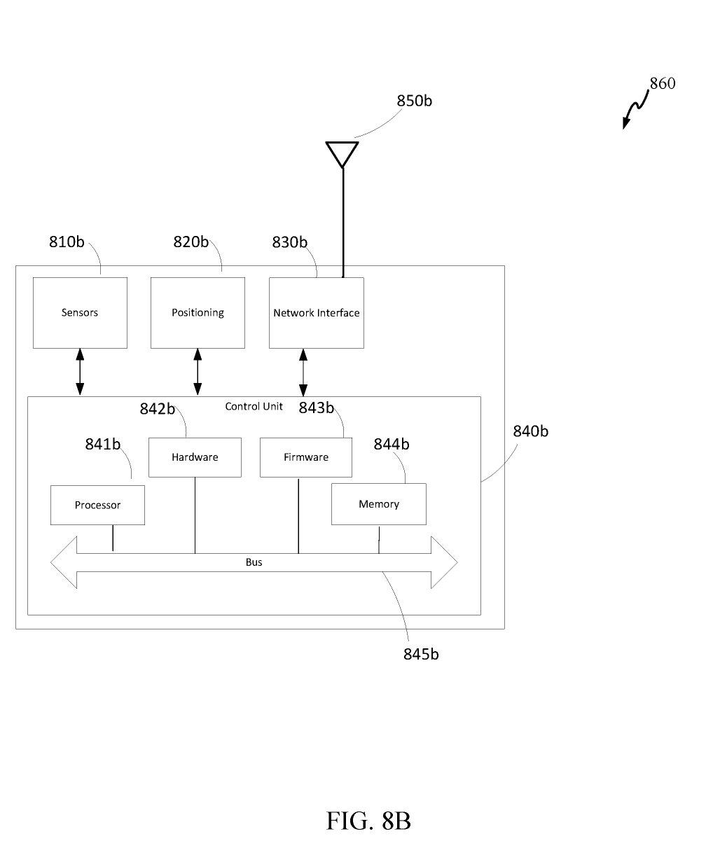

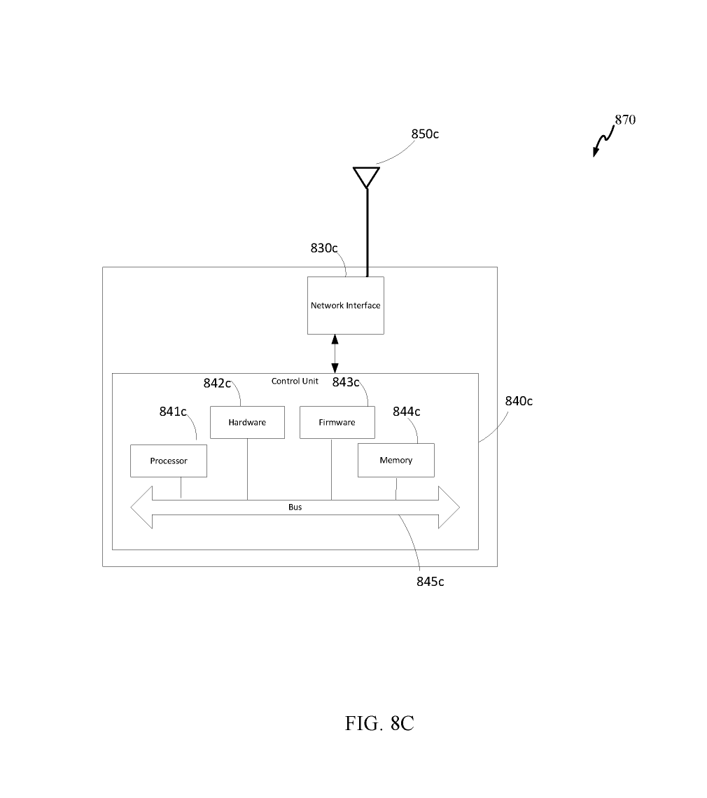

FIG. 8A shows an example device 800 of a peripheral device 155 in which various aspects of the disclosure may be implemented. FIG. 8B shows an example device 860 of a mobile gateway 100 in which various aspects of the disclosure may be implemented. FIG. 8C shows an example device 870 of a server 140 in which various aspects of the disclosure may be implemented.

According to aspects of the disclosure, the device 800,860 may also include a position location system 820, 820b. The position location system 820, 820b may include a satellite positioning system, a terrestrial based positioning system or a combination thereof. The position location system 820, 820b may include antenna(s), receiver(s), circuitry for processing signals/determining position, or any combination thereof. The position location system 820, 820b may utilize communication signals, via the network interface 830,830b, from various wireless technologies, such as Code Division Multiple Access (CDMA), Wideband Code Division Multiple Access (WCDMA), Long Term Evolution (LTE), Worldwide Interoperability for Microwave Access (WiMAX), Wi-Fi, Bluetooth, etc. for determining the device's position. The position location system 820,820b may utilize one or more sensors 810,810b to augment other positioning technologies and/or determine a position. In an implementation, the position location system 820,820b may utilize a camera, an optical sensor and/or other sensors to determine a position or relative position using Simultaneous Localization and Mapping (SLAM) and/or Landmark Based Positioning. The position location system may 820,820b may be used to notify the peripheral device 155 and/or the mobile gateway 100 of an upcoming period in which the peripheral device 155 and/or the mobile gateway 100 will be in standalone mode. For example, the position location system may determine the location of the peripheral device 155 and/or mobile gateway 100 and the peripheral device and/or the mobile gateway 100 may use this location to determine its proximity to a deadzone or an area where it expects will be out of service (e.g. airport so the user is likely to be on an airplane) and use proximity as a notification trigger as described herein. In another example, the peripheral device 155 may obtain an indication for service similar to block 610 based on the position location system 820.

In an implementation, device 800,860 may include one or more sensors 810, 810b. The sensors 810, 810b may include accelerometers, magnetometers, gyroscopes, light sensors, proximity sensors, microphones, pressure sensors, microphones, cameras, etc. The sensors 810, 810b may be used individually or in combination, and the sensors may be able to operate independent of one another or may be used interdependently. The one or more sensors may also be used to notify the peripheral device 155 and/or the mobile gateway 100 of an upcoming period in which the peripheral device 155 and/or the mobile gateway 100 of an upcoming period in which the peripheral device 155 and/or the mobile gateway 100 will be in standalone mode. For example, the one or more sensors 810, 810b may include a microphone that is periodically listening and it may be able to distinguish the user is on an airplane or in an airport from this information and it likely to lose connectivity with a server 140. As a result, it may notify the peripheral device 155 and/or the mobile gateway 100 of the upcoming period in which one or both of the devices may be in standalone mode. In another example, the peripheral device 155 may obtain an indication for service similar to block 610 based on the one or more sensors 810.

The control unit 840,840b,840c may include at least one processor 841,841b,841c; hardware 842,842b,842c; firmware 843,843b,843c; and memory 844,844b,844c. The at least one processor 841,841b,841c may be a digital signal processor (DSP), compute processing unit (CPU), graphic processing unit (GPU), vision processing unit (VPU), neural processing unit (NPU), microcontroller or any combination thereof. For example, the processor 841,841b,841c may be a single processor such as a CPU or it may be multiple processors 841,841b,841c, such as two CPUs and GPU. The processors 841,841b,841c may be in a single package or multiple packages. For example, the processors 841,841b,841c may be in multiple discreet chipsets that may be on a single printed circuit board, multiple printed circuit boards, may be packages that are able to at least partially be stack on top of each other, or may be in a single package. Those components may communicate and interact thru a system bus 845,845b,845c.

The control unit 840 of the peripheral device 155 may determine whether to send a service request based on proximity to a mobile gateway 100, connectivity status, response from provisioning request or any combination thereof, similar to block 620. For example, the network interface 830 may receive signals from the mobile gateway 100 and may provide it to at least one processor 841 and the memory 844 which may then determine whether to send a service request as described herein.

In an example of the mobile gateway 100, the network interface 830b of a mobile gateway 100 may receive one or more provisioning requests from the peripheral device(s) 155, similar to block 310 and/or block 510, and provide that to the control unit 840b, such as the processor(s) 841b and memory 844b, the control unit 840b may then determine whether to handle the one or more provisioning requests based on capabilities of the mobile gateway 100, similar to block 320 and/or block 520. It may then send via the network interface 830b, to a server 140, a request for one or more applications to service the peripheral device(s) 155, similar to block 330 and/or 530.

In another example, the control unit 840b of the mobile gateway 100 may determine connection characteristics to determine whether to handle the request or forward the request on to the server 140, similar to block 720 and 740.

In an example of the server 140, the network interface 830c of the server 140 may receive at least one application request from a mobile gateway 100, similar to block 410, and the control unit 840c, such as the processor(s) 841c and memory 844c, may identify one or more applications to provide the mobile gateway 100 based on the application requests and capabilities of the mobile gateway 100, similar to block 420. After identifying the application(s) the control unit 840c of the server 140 may send the application(s) via the network interface 830c to the mobile gateway 100, similar to block 430.

The device 800, 860, 870 may include one or more network interfaces 830, 830b, 830c configured for communication with a network. Consistent with some implementations, the network interface 830, 830b, 830c may be configured to interface with a coaxial cable, a fiber optic cable, a digital subscriber line (DSL) modem, a public switched telephone network (PSTN) modem, other modem types, an Ethernet device, and/or various other types of wired network communication devices. The network interface 830 may also include one or more wireless transceivers, wherein each wireless transceiver may include an antenna that is separate or integrated and is capable of transmitting and receiving information according to a different wireless networking protocol, such as Wi-Fi™, one or more 3G protocols, one or more 4G protocols (such as LTE or LTE Advanced), High-Speed Downlink Packet Access (HSDPA), 5G, Near Field Communications (NFC), Bluetooth (such as Bluetooth LE, Bluetooth 5, etc) or any combination thereof.

According to an aspect of the disclosure, the one or more network interfaces 830, 830b, 830c may include one or more basebands, one or more transceivers, one or more RF front end components (e.g. power amplifiers, envelope tracker, filters, etc), and one or more antennas 850, 850b, 850c.

In an implementation, the device 800, 860, 870 may include additional components not specifically listed in the specification and/or in the drawings. As an example, the device 800, 860, 870 may include a display, one or more cameras, one or more microphones, one or more speakers, etc.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Wireless communication techniques described herein may be in connection with various wireless communications networks such as a wireless wide area network (“WWAN”), a wireless local area network (“WLAN”), a wireless personal area network (WPAN), and so on. The term “network” and “system” may be used interchangeably herein. A WWAN may be a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) network, a Single-Carrier Frequency Division Multiple Access (“SC-FDMA”) network, 5G network, or any combination of the above networks, and so on. A CDMA network may implement one or more radio access technologies (“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a cellular transceiver device, utilized to extend cellular telephone service into a business or home. In such an implementation, one or more mobile gateways may communicate with a cellular transceiver device via a code division multiple access (“CDMA”) cellular communication protocol, for example.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

For an implementation involving firmware and/or software, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable storage medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer-readable storage medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

1. A method of a mobile gateway, the method comprising:
receiving, from at least one peripheral device, one or more provisioning requests to provide service to the at least one peripheral device;
determining whether to handle the one or more provisioning requests based on capabilities of the mobile gateway;
in response to the determination to handle the one or more provisioning requests, requesting, from a server, at least one application based on the one or more provisioning requests;
receiving at least one service request from the at least one peripheral device while network connectivity is unavailable; and
providing service to the at least one peripheral device, on behalf of the server while the network connectivity is unavailable, based on the at least one service request and the at least one application.

2. The method of claim 1, further comprising:
determining whether to handle the at least one service request based on constraints of the mobile gateway; and
in response to the determination to handle the at least one service request, providing the service to the at least one peripheral device, while the network connectivity is unavailable, based on the at least one service request and the at least one application.

3. The method of claim 1, further comprising:
in response to receiving the at least one application, notifying the at least one peripheral device that the mobile gateway is enabled to handle one or more service requests from the at least one peripheral device; and
in response to receiving a rejection from the server, notifying the at least one peripheral device that the mobile gateway is unable to handle the one or more service requests from the at least one peripheral device.

4. The method of claim 1, wherein the capabilities of the mobile gateway comprise: processing power, battery capacity, wireless communication protocols, wireless throughput, wireless latency, memory capacity, constraints, or any combination thereof.

5. The method of claim 4, wherein the constraints of the mobile gateway comprise: power level, resource usage, or any combination thereof.

6. The method of claim 1, further comprising:
in response to a determination that the mobile gateway is in standalone mode, selectively transmitting one or more server requests to the server based on the one or more service requests and the at least one application.

7. The method of claim 1, wherein the determining whether to handle the one or more provisioning requests is further based on quality of service, urgency level, priority of the one or more provisioning requests, service type, duration request, start time, end time, location/route, connection priority, an identifier of the at least one peripheral device or any combination thereof.

8. A mobile gateway, comprising:
a transceiver configured to receive, from at least one peripheral device, one or more provisioning requests to provide service to the at least one peripheral device;
a memory;
one or more processors coupled to the memory and the transceiver, the one or more processors configured to:
determine whether to handle the one or more provisioning requests based on capabilities of the mobile gateway; and
in response to the determination to handle the one or more provisioning requests, request, from a server, at least one application based on the one or more provisioning requests;
receive at least one service request from the at least one peripheral device while network connectivity is unavailable; and
provide service to the at least one peripheral device, on behalf of the server while the network connectivity is unavailable, based on the at least one service request and the at least one application.

9. The mobile gateway of claim 8, wherein the one or more processors is further configured to:
determine whether to handle the at least one service request based on constraints of the mobile gateway; and
in response to the determination to handle the at least one service request, providing the service to the at least one peripheral device, while the network connectivity is unavailable, based on the at least one service request and the at least one application.

10. The mobile gateway of claim 8, wherein the one or more processors further configured to:
in response to reception of the at least one application, notify the at least one peripheral device that the mobile gateway is enabled to handle one or more service requests from the at least one peripheral device; and
in response to reception of a rejection from the server, notify the at least one peripheral device that the mobile gateway is unable to handle the one or more service requests from the at least one peripheral device.

11. The mobile gateway of claim 8, wherein the capabilities of the mobile gateway comprise: processing power, battery capacity, wireless communication protocols, wireless throughput, wireless latency, memory capacity, constraints, or any combination thereof.

12. The mobile gateway of claim 11, wherein the constraints of the mobile gateway comprise: power level, resource usage, or any combination thereof.

13. The mobile gateway of claim 8, wherein the one or more processors further configured to:
in response to a determination that the mobile gateway is in standalone mode, selectively initiate transmission of one or more server requests to the server based on the one or more service requests and the at least one application.

14. The mobile gateway of claim 8, wherein the one or more processors further configured to determine whether to handle the one or more provisioning requests based on quality of service, urgency level, priority of the one or more provisioning requests, service type, duration request, start time, end time, location/route, connection priority, an identifier of the at least one peripheral device or any combination thereof.

15. A mobile gateway comprising:
means for receiving, from at least one peripheral device, one or more provisioning requests to provide service to the at least one peripheral device;
means for determining whether to handle the one or more provisioning requests based on capabilities of the mobile gateway; and
in response to the determination to handle the one or more provisioning requests, means for requesting, from a server, at least one application based on the one or more provisioning requests;
means for receiving at least one service request from the at least one peripheral device while network connectivity is unavailable; and
means for providing service to the at least one peripheral device, on behalf of the server while the network connectivity is unavailable, based on the at least one service request and the at least one application.

16. The mobile gateway of claim 15, further comprising:
means for determining whether to handle the at least one service request based on constraints of the mobile gateway; and
in response to the determination to handle the at least one service request, means for providing the service to the at least one peripheral device, while the network connectivity is unavailable, based on the at least one service request and the at least one application.

17. The mobile gateway of claim 15, further comprising:
in response to receiving the at least one application, means for notifying the at least one peripheral device that the mobile gateway is enabled to handle one or more service requests from the at least one peripheral device; and
in response to receiving a rejection from the server, means for notifying the at least one peripheral device that the mobile gateway is unable to handle the one or more service requests from the at least one peripheral device.

18. The mobile gateway of claim 15, wherein the capabilities of the mobile gateway comprise: processing power, battery capacity, wireless communication protocols, wireless throughput, wireless latency, memory capacity, constraints or any combination thereof.

19. The mobile gateway of claim 18, wherein the constraints of the mobile gateway comprise: power level, resource usage, or any combination thereof.

20. The mobile gateway of claim 15, further comprising:
in response to a determination that the mobile gateway is in standalone mode, means for selectively transmitting one or more server requests to the server based on the one or more service requests and the at least one application.

21. The mobile gateway of claim 15, wherein the means for determining whether to handle the one or more provisioning requests is further based on quality of service, urgency level, priority of the one or more provisioning requests, service type, duration request, start time, end time, location/route, connection priority, an identifier of the at least one peripheral device or any combination thereof.

22. A non-transitory computer-readable medium comprising processor-executable program code configured to cause a processor to:
receive, from at least one peripheral device, one or more provisioning requests to provide service to the at least one peripheral device;
determine whether to handle the one or more provisioning requests based on capabilities of a mobile gateway; and
in response to the determination to handle the one or more provisioning requests, request, from a server, at least one application based on the one or more provisioning requests;
receive at least one service request from the at least one peripheral device while network connectivity is unavailable; and
provide service to the at least one peripheral device, on behalf of the server while the network connectivity is unavailable, based on the at least one service request and the at least one application.

23. The non-transitory computer-readable medium of claim 22, wherein the processor-executable program code is further configured to cause the processor to:
determine whether to handle the at least one service request based on constraints of the mobile gateway; and
in response to the determination to handle the at least one service request, providing the service to the at least one peripheral device, while the network connectivity is unavailable, based on the at least one service request and the at least one application.

24. The non-transitory computer-readable medium of claim 22, wherein the processor-executable program code is further configured to cause the processor to:
in response to reception of the at least one application, notify the at least one peripheral device that the mobile gateway is enabled to handle one or more service requests from the at least one peripheral device; and
in response to reception of a rejection from the server, notify the at least one peripheral device that the mobile gateway is unable to handle the one or more service requests from the at least one peripheral device.

25. The non-transitory computer-readable medium of claim 22, wherein the capabilities of the mobile gateway comprise: processing power, battery capacity, wireless communication protocols, wireless throughput, wireless latency, memory capacity, constraints, or any combination thereof.

26. The non-transitory computer-readable medium of claim 25, wherein the constraints of the mobile gateway comprise: power level, resource usage, or any combination thereof.

27. The non-transitory computer-readable medium of claim 22, wherein the processor-executable program code is further configured to cause the processor to:
in response to a determination that the mobile gateway is in standalone mode, selectively transmit one or more server requests to the server based on the one or more service requests and the at least one application.

28. The non-transitory computer-readable medium of claim 22, wherein the processor-executable program code configured to cause the processor to determine whether to handle the one or more provisioning requests is further based on quality of service, urgency level, priority of the one or more provisioning requests, service type, duration request, start time, end time, location/route, connection priority, an identifier of the at least one peripheral device or any combination thereof.
